(19) United States
(12) Patent Application Publication
(10) Pub. No.: US 2010/0145579 A1
(43) Pub. Date: Jun. 10, 2010

(54) METHOD AND SYSTEM FOR ONBOARD ZERO OFFSET COMPENSATION FOR ELECTRIC POWER ASSIST STEERING TORQUE SENSOR

(75) Inventor: Gary O'Brien, Riverview, MI (US)

Correspondence Address: HONEYWELL/CST;Patent Services, 101 Columbia Road, P.O. Box 2245, Morristown, NJ, 07962-2245, US

(73) Assignee: Honeywell International Inc.

(21) Appl. No.: 12/332,192

(22) Filed: Dec. 10, 2008

(51) Int. Cl. B62D 5/04; G06F 17/00

(52) U.S. Cl. 701/42; 180/446

(57) ABSTRACT

A method and system for onboard zero offset compensation for ATV electric power assist steering (EPAS) torque sensor. An electric assist torque can be applied to an EPAS motor in a clockwise and a counterclockwise direction until a movement is generated in a steering column. A threshold value of torque signal generated by the torque sensor in both directions can be stored when the applied torque exceeds a reaction torque to cause acceleration of a shaft. The reaction torque can be determined under conditions such as, for example, when no one is holding the handle bars and the wheels are free from obstruction. The magnitude of the torque signals are approximately equivalent and an absolute magnitude of the torque signals falls below a general torque limit that can be set under ideal conditions with the ATV. Thereafter, an auto zeroing operation can be performed a number of times throughout the life of the ATV and the error due to offset drift of the sensor can be reduced.

### TECHNICAL FIELD

Embodiments are generally related to vehicle steering systems. Embodiments are also related to electric power assist steering (ERAS) torque sensors. Embodiments are additionally related to methods for onboard zero offset compensation for ERAS torque sensors utilized in vehicles, such as, for example, All Terrain Vehicles (ATVs).

### BACKGROUND OF THE INVENTION

The electric power assist steering (ERAS) system employs an electric motor for applying a controlled amount of torque to a steering assembly to assist an operator with angular rotation of a steering wheel. The ERAS system reduces the amount of steering effort by directly applying the output from the electric motor to the steering system of an All Terrain Vehicle (ATV). ERAS system generally includes a torque sensor, which can be arranged so that the level of torque in a steering column can be measured. An electric controller calculates the value of a torque demand signal utilizing the torque level, which includes an assistance torque component indicative of the torque that is to be generated by the electric motor attached to the steering column. Based on the controller calculations, the motor applies an assistance torque to the steering column that is demanded by the driver and thus reduces the effort needed to turn the wheel.

Various engine parameters, including throttle position, ignition timing, engine air-fuel ratio, engine airflow, control engine torque, and speed can be utilized to control input torque or input speed, depending on the shift phase. EPAS torque sensor applications require highly accurate and repeatable performance at zero torque point. One of the problems with on-board torque sensors is that they experience zero offset drift over the life of the vehicle. Excessive zero offset drift in the EPAS torque sensor can result in unintentional electrical assist of the steering system when the driver is not applying torque on the steering with the intent to turn the vehicle. Also, performing a one time zeroing of the torque sensor during the production of the vehicle would not be sufficient since drift will occur as the vehicle is driven.

Based on the foregoing, it is believed that a need exists for an improved onboard method of auto zeroing the torque sensor in the ATV throughout the course of the vehicle lifetime to compensate for offset drifts, as described in greater detail herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved electric power assist steering torque sensor apparatus for vehicles.

It is another aspect of the present invention to provide for an improved method for onboard zero offset compensation for EPAS torque sensors utilized in vehicles, such as, but not limited to, All Terrain Vehicles (ATVs).

It is a further aspect of the present invention to provide for an improved onboard method of auto zeroing a torque sensor in a vehicle, such as an ATV, throughout the course of the vehicle lifetime.

The aforementioned aspects and other objectives and advantages can now be achieved as described herein. A method and system for onboard zero offset compensation for ATV electric power assist steering (EPAS) torque sensor is disclosed. An electric assist torque can be applied to an EPAS motor in a clockwise and a counterclockwise direction until a movement is generated in a steering column. A threshold value of torque signal generated by the torque sensor in both directions can be stored when the applied torque exceeds a reaction torque to cause acceleration of a shaft. Note that since the torque sensor is generally located between a motor assist and the handlebar(s), it does not matter if the ATV is located on level ground because the torque sensor does not “see” or is “not aware” of the torque applied by the motor reacted to by the wheels. That is, the sensor only “sees” the torque between the handlebar(s) and the shaft at the motor assist location.

The magnitude of the torque signals are approximately equivalent and an absolute magnitude of the torque signals falls below a general torque limit that can be set under conditions when it is known that no one is holding onto the handle bars. Thereafter, an auto zeroing operation can be performed a number of times throughout the life of the ATV and the error due to offset drift of the sensor can be reduced.

The torque threshold is similar to a force that is required to break static friction to move the steering shaft. The torque sensor signals, as a result of the EPAS assist motor test signals, possess approximate symmetry in the magnitude of torque required to cause movement in the shaft. The movement of the shaft can be detected by a steering angle sensor. The torque sensor can be arranged so that the level of torque in the steering column can be measured. From this measurement, the EPAS motor controller calculates the value of the torque demand signal, which includes an assistance torque component that is indicative of the torque that is to be generated by the EPAS motor attached to the steering column. The EPAS motor applies an assistance torque to the column of the same sense as that demanded by the driver and thus reduces the effort needed to turn the wheel. Similarly, the EPAS motor assist test can be performed both before and after the auto zeroing operation to help insure that no one grabbed the steering column after the near zero or zero torque condition is identified. Such an onboard method of auto zeroing the torque sensor in the ATV throughout the course of the vehicle lifetime compensates offset drift.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram of an electric power assist steering system, which can be implemented in accordance with a preferred embodiment;

FIG. 2 illustrates a schematic view of an electric power assist steering system in an All Terrain Vehicle (ATV), which can be implemented in accordance with a preferred embodiment; and

FIG. 3 illustrates a detailed flow chart of operation illustrating logical operational steps of a method for onboard zero offset compensation for an electric power assist steering torque sensor, which can be implemented in accordance with a preferred embodiment.

### DETAILED DESCRIPTION

The particular values and configurations discussed in these non-limiting examples can be varied and are cited merely to illustrate at least one embodiment and are not intended to limit the scope thereof.

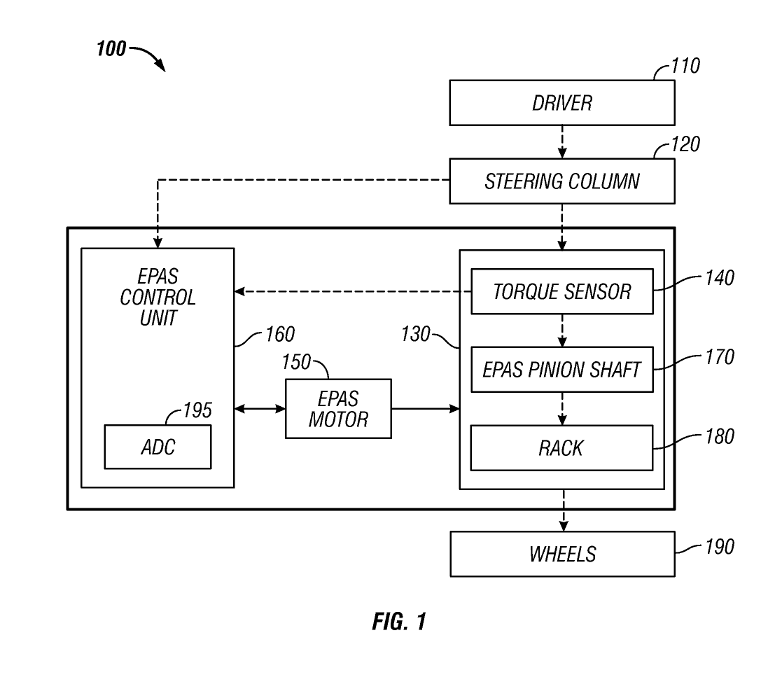

FIG. 1 illustrates a block diagram of an electric power assist steering system 100, which can be implemented in accordance with a preferred embodiment. The electric power assist steering system 100 can be utilized in a vehicle such as an All Terrain Vehicle (ATV) to provide an external power assist torque to assist an operator with angular rotation of a steering wheel. The EPAS system 100 for auto zeroing a power train torque sensor is first composed of a torque sensor 140, which can be utilized for outputting a signal corresponding to a value of the steering torque of a driver 110. An EPAS electric motor 150 can be utilized for driving a steering gear column 130, which assists the steering force of the EPAS system 100. The steering gear column 130 generally includes a pinion shaft 170, which can be utilized to drive a rack 180 of the steering gear column 130. The pinion shaft 170 can provide a 90-degree drive to the rack 180 of the steering gear column 130. The rack 180 can be utilized to connect the EPAS system 100 to the wheels 190 of an ATV.

The EPAS system 100 includes an EPAS motor controller 160 for determining current flowing through the electric motor 150 in accordance with the output signal of the torque sensor 140. In general, the torque sensor 140 can be utilized to convert a torsional torque of a steering column 120 into an analog signal (voltage). Further, the analog signal from the torque sensor 140 can be fed into the EPAS motor controller 160. The EPAS motor controller 160 can include an analog to digital converter (ADC) circuit 195 which can be utilized to convert the analog signal to a corresponding digital value. If the torque sensed by the torque sensor 140 is high, the assist provided by the EPAS motor controller 160 to the steering gear column 130 will also be high.

In case the torque sensed by the torque sensor 140 is low, the assist applied by the EPAS controller 160 to the steering gear column 130 will also be low. The torque sensor 140 may detect magnitudes that fall below a general limit. The torque sensor 140 can also be configured to determine magnitudes under conditions of known near zero torque, such as, for example, with respect to the handlebars of a representative ATV. An auto zero operation can be performed with respect to the torque sensor 140 to reduce the error due to offset drift in the EPAS system 100. Note that the embodiments discussed herein should not be construed in any limited sense. It can be appreciated that such embodiments reveal details of the structure of a preferred form necessary for a better understanding of the invention and may be subject to change by skilled persons within the scope of the invention without departing from the concept thereof.

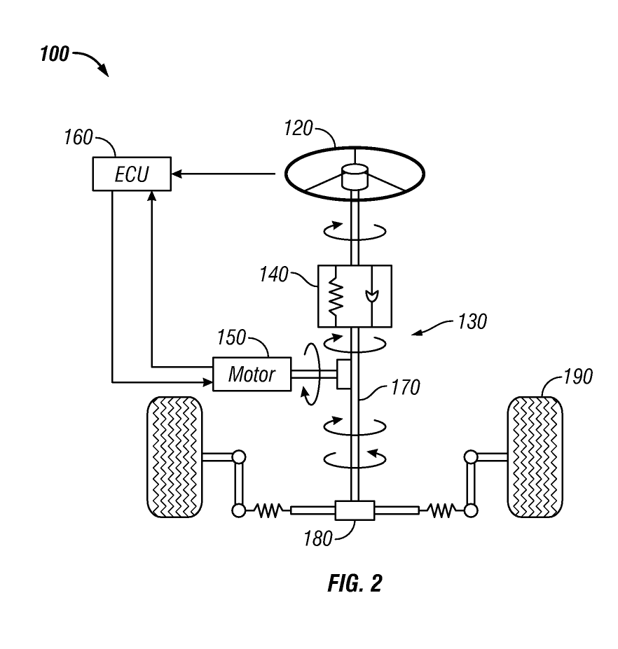

FIG. 2 illustrates a perspective view of an electric power assist steering system 100 in an All Terrain Vehicle (ATV), which can be implemented in accordance with a preferred embodiment. Note that in FIGS. 1-3, identical or similar parts are generally indicated by identical reference numerals. The EPAS system 100 can utilize the torque sensor 140 that can be assigned to the steering column 120 for measuring the steering movement applied by the driver 110. The driver 110 can apply a steering movement via the steering column 120 to the steering gear column 130. Optionally, the steering column 120 can have a steering angle sensor according to the state of the art. The steering gear column 130 can include the pinion shaft 170 which can be utilized to transmit the steering movement of the driver 110 to the rack 180. The steering movement is supported through the support gear column 130, which in turn is driven by the EPAS electric motor 150.

The torque sensor 140 usually serves exclusively for measuring the torque, but can also be combined with an angle-of-rotation sensor in circumstances. In general, torque measurement can be performed to detect the torque induced by a driver's 110 operation utilizing the steering column 120 in the EPAS system 100, or to detect the torque in the rotational direction of wheels 190 when running. The output of the torque sensor 140 indicates how much force the driver 110 can exert to move the wheel 190. The output signal from the torque sensor 140 can be fed into the EPAS motor controller 160, which controls the EPAS motor 150.

An electric assist torque can be applied to the EPAS motor 150 from zero and slowly ramp the torque in clockwise and counterclockwise directions until a movement is generated in the steering column 120. A threshold value of torque signals generated by the torque sensor 140 in both directions can be stored when the applied torque exceeds a reaction torque to cause acceleration of the shaft 170. The steering angle sensor associated with the steering column 120 can detect the movement of the shaft 170. The reaction torque can be determined under certain conditions such as, for example, with the wheels free of any obstacle that would prevent easy movement of the steering column with the EPAS motor. Note that such a situation is more general than smooth level ground or so-called “ideal” conditions. A user simply needs to be able to move the steering shaft back and forth in order for this feature to function. There could, for example, be some resistance at the wheel and the sensor unable to “see” if no one is holding the handle bars.

The magnitude of the torque signals generated by the torque sensor 140 are approximately equivalent and an absolute magnitude of the torque signals falls below a general torque limit that can be set under ideal conditions with the ATV EPAS system 100. Thereafter, an auto zeroing operation can be performed a number of times throughout the life of the ATV EPAS system 100 and the error due to offset drift of the sensor 140 can be reduced. The threshold value of torque signals is similar to a force that is required to break static friction to move the steering shaft 170. The torque sensor signals as a result of the EPAS assist motor test signals possess approximate symmetry in the magnitude of torque required to cause movement in the shaft 170.

In addition, the magnitude of the positive and negative signals of the torque sensor 140 as a result of an EPAS assist motor test can be equivalent if no one is holding onto the steering column 120 or no other asymmetric force is acting on the wheels 190. For example, the ATV EPAS system 100 can be parked with the wheels 190 wedged tight against an obstacle. This results in a nonsymmetrical reaction torque that would prevent zeroing. The ATV EPAS system 100 might be able to move the steering column 130 slightly in the direction away from the obstacle so that the ATV EPAS system 100 can get into a position of symmetric reaction torque.

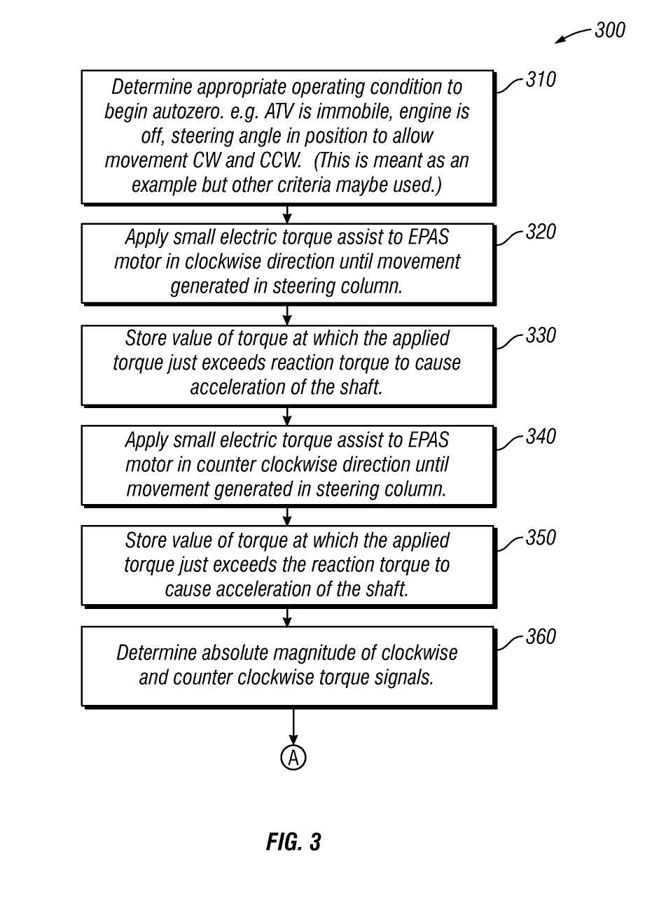

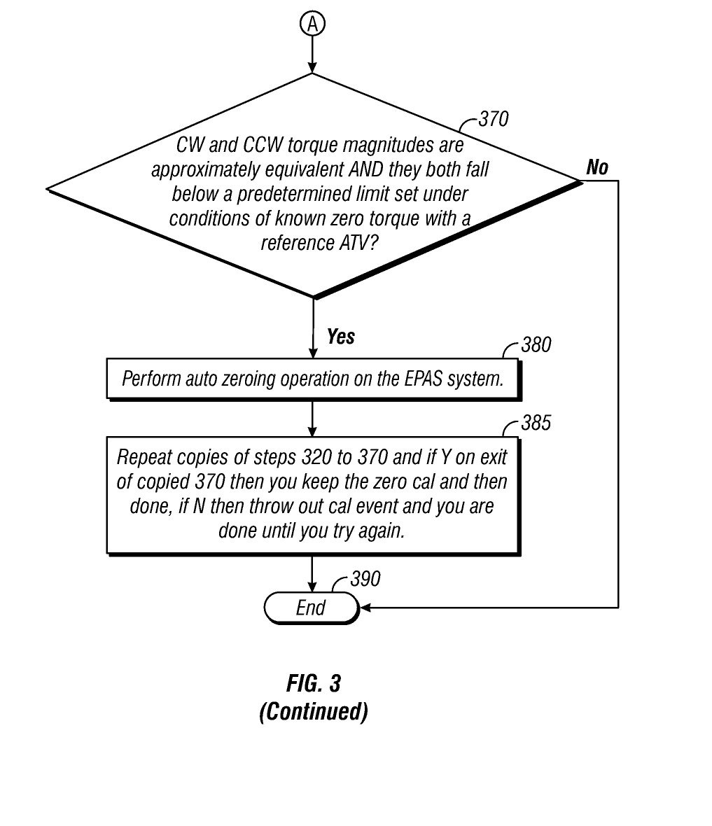

FIG. 3 illustrates a detailed flow chart of operation illustrating logical operational steps of a method 300 for onboard zero offset compensation for an electric power assist steering torque sensor 140 in an All Terrain Vehicle (ATV), which can be implemented in accordance with a preferred embodiment. In general, the onboard zero offset compensation method 300 can be utilized for determining conditions during the operation of the ATV when it is likely that there is a near zero or zero torque applied to the steering column 120 so that an auto zeroing operation can be performed.

The reaction torque under a condition (e.g., when no one is holding the handle bars and the wheels are free from obstruction) can be determined, as shown at block 310. That is, the operation depicted at block 310, can be processed to determine appropriate operating conditions to begin the disclosed auto zeroing operation (e.g., ATV is immobile, engine is off, steering angle in position to allow movement CW and CCW, etc). Note that these are merely examples, and other criteria may be used. Following the processing of the operation illustrated at block 310, the operation depicted at block 320 can be processed.

As indicated at block 320, an electric assist torque can be applied to the EPAS motor 150 in a clockwise direction until a movement is generated in the steering column 120. Thereafter, as depicted at block 330, the output signal of the torque sensor 140 can be stored when the applied torque on the EPAS motor 150 just exceeds the reaction torque to cause acceleration of the shaft 170. Further, an electric assist torque can be applied to the EPAS motor 150 in a counterclockwise direction until a movement is generated in the steering column 120, as described at block 340. Later, as depicted at block 350, the output signal of the torque sensor 140 can be stored when the applied torque on the EPAS motor 150 just exceeds the reaction torque to cause acceleration of the shaft 170. The torque threshold or the reactive torque is similar to the force that is required to break static friction i.e., no movement will be there in the steering column 120 until the force threshold is reached and then movement of the steering column 120 takes place.

The magnitude of the positive and negative torque sensor signals generated by the torque sensor 140 are approximately equivalent. The absolute magnitude of the clockwise and counterclockwise torque signals can be determined, as shown at block 360. Following the processing of the operation depicted at block 360, a test can be performed, as indicated at block 370. A determination can be made as to whether the absolute magnitude of the positive and negative torque sensor signals generated by the torque sensor 140 falls below a general limit set under when no one is holding the handle bars and the wheels are free from obstruction as depicted at block 370.

The operation depicted at block 370 essentially describes a test condition in which CW (Clockwise) and CCW (Counterclockwise) torque magnitudes are approximately equivalent AND both magnitudes fall below a predetermined limit set under conditions of known zero torque with a reference ATV. Following processing of the operation illustrated at block 370, the operation depicted at block 380 can be processed, assuming a “Y” or “Yes” response. If an “N” or “No” response results from performing the test depicted at block 370, then the process terminates, as indicated at block 390. Note that the operation depicted at block 380 involves performing an auto zeroing operation with respect to the EPAS system 100. Note that after the operation depicted at block 380 is complete, an operation can be implemented as indicated at block 385 in which steps 320 to 270 are repeated and if a “Y” or “Yes” response occurs (in response to the operation depicted at block 370), the zero cal value is maintained and the process then ends as depicted at block 390. If the answer is “N” or “No”, then the cal even value is discarded and the process terminated as indicated at block 390.

The torque sensor 140 associated with the EPAS system 100 can be arranged so that a particular level of torque in the steering column 120 is capable of being measured. From this measurement, the EPAS motor controller 160 can calculate the value of a torque demand signal, which includes an assistance torque component that is indicative of the torque that is to be generated by the EPAS motor 150 attached to the steering gear column 130. The EPAS motor 150 applies an assistance torque to the column of the same sense as that demanded by the driver and thus reduces the effort needed to turn the wheels 190. Similarly, the EPAS motor assist test can be performed both before and after the auto zeroing operation to help insure that no one grabbed the steering column after the near zero or zero torque condition is identified. Such an onboard method 300 of auto zeroing the torque sensor 140 in the ATV throughout the course of the vehicle's lifetime compensates offset drift.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for compensating a torque sensor, comprising:
applying a torque with a steering motor connected to a steering column in a clockwise direction and a counterclockwise direction until a movement is generated with respect to said steering column;
storing a threshold value of a torque signal determined by a torque sensor in said clockwise direction and said counterclockwise direction, when said torque exceeds a reaction torque in order to cause an acceleration of a shaft, such that said reaction torque is determined; and
performing an auto zeroing operation a particular number of times if a magnitude of a positive signal and a negative signal of said torque sensor are approximately equal and an absolute magnitude of said positive and said negative signal falls below a general torque limit set under conditions of known near zero reaction torque on handlebars associated with a similar vehicle, thereby reducing an error due to an offset drift of said torque sensor.

2. The method of claim 1 wherein said torque comprises an electric assist torque.

3. The method of claim 1 wherein said steering motor comprises an electric power assist steering motor.

4. The method of claim 1 wherein performing said auto zeroing operation further comprises:
comparing a magnitude of said positive signal and said negative signal of said torque sensor before and after performing said auto zeroing operation, in order to maximize the confidence that no reaction forces were applied to a steering column via a handlebar when said auto zeroing was taking place,

5. The method of claim 1 wherein performing an auto zeroing operation further comprises:
comparing a magnitude of said positive signal and said negative signal of said torque sensor before and after performing said auto zeroing operation, in order to maximize the confidence that no reaction forces were applied to a steering column via a handlebar when said auto zeroing was taking place.

6. The method of claim 1 wherein said torque sensor is associated with an all-terrain vehicle.

7. The method of claim 1 wherein said torque sensor is arranged such that a level of said torque in said steering column is measureable.

8. The method of claim 1 further comprising:
associating a controller with said steering motor, wherein said controller calculates a value of said torque.

9. The method of claim 8 further comprising:
associating an assistance torque component with said controller, wherein said assistance torque component is indicative of a torque generated by said steering motor attached to said steering column.

10. The method of claim 8 wherein said controller comprises an EPAS controller.

11. A method for compensating a torque sensor, comprising:
applying a torque with a steering motor connected to a steering column in a clockwise direction and a counterclockwise direction until a movement is generated with respect to said steering column;
storing a threshold value of a torque signal determined by a torque sensor in said clockwise direction and said counterclockwise direction, when said torque exceeds a reaction torque in order to cause an acceleration of a shaft, such that said reaction torque is determined;
performing an auto zeroing operation a particular number of times if a magnitude of a positive signal and a negative signal of said torque sensor are approximately equal and an absolute magnitude of said positive and said negative signal falls below a general torque limit set under conditions of known near zero reaction torque on handlebars associated with a similar vehicle, thereby reducing an error due to an offset drift of said torque sensor;
associating a controller with said steering motor, wherein said controller calculates a value of said torque; and
associating an assistance torque component with said controller, wherein said assistance torque component is indicative of a torque generated by said steering motor attached to said steering column.

12. A torque sensor compensation system, comprising:
a steering motor connected to a steering column, wherein a torque is applicable to said steering motor connected to said steering column in a clockwise direction and a counterclockwise direction until a movement is generated with respect to said steering column;
a memory storing a threshold value of a torque signal determined by a torque sensor in said clockwise direction and said counterclockwise direction, when said torque exceeds a reaction torque in order to cause an acceleration of a shaft, such that said reaction torque is determined; and
an auto zeroing mechanism performing an auto zeroing operation a particular number of times if a magnitude of a positive signal and a negative signal of said torque sensor are approximately equal and an absolute magnitude of said positive and said negative signal falls below a general torque limit set under conditions of known near zero reaction torque on handlebars associated with a similar vehicle, thereby reducing an error due to an offset drift of said torque sensor.

13. The system of claim 12 wherein said torque comprises an electric assist torque.

14. The system of claim 12 wherein said steering motor comprises an electric power assist steering motor.

15. The system of claim 12 said auto zeroing mechanism for performing said auto zeroing operation further comprises:
a comparison mechanism for comparing a magnitude of said positive signal and said negative signal of said torque sensor before and after performing said auto zeroing operation, in order to maximize the confidence that no reaction forces were applied to a steering column via a handlebar when said auto zeroing was taking place.

16. The system of claim 12 said auto zeroing mechanism for performing said auto zeroing operation further comprises:
a comparison mechanism for comparing a magnitude of said positive signal and said negative signal of said torque sensor before and after performing said auto zeroing operation, in order to maximize the confidence that no reaction forces were applied to a steering column via a handlebar when said auto zeroing was taking place.

17. The system of claim 12 wherein said torque sensor is associated with an all-terrain vehicle.

18. The system of claim 12 wherein said torque sensor is arranged such that a level of said torque in said steering column is measureable.

19. The system of claim 12 further comprising:
a controller associated with said steering motor, wherein said controller calculates a value of said torque.

20. The system of claim 12 further comprising:
an assistance torque component associated with said controller, wherein said assistance torque component is indicative of a torque generated by said steering motor attached to said steering column.
